(19) United States
(12) Patent Application Publication
(10) Pub. No.: US 2021/0078895 A1
(43) Pub. Date: Mar. 18, 2021

(54) SYSTEMS AND METHODS FOR FORMING GLASS RIBBON USING A HEATING DEVICE

(71) Applicant: CORNING INCORPORATED, Corning, NY (US)

(72) Inventors: Curtis Robert Fekety, Corning, NY (US); Miki Eugene Kunitake, Elmira, NY (US); Ilia Andreyevich Nikulin, Painted Post, NY (US); Chao Yu, Pittsford, NY (US)

(21) Appl. No.: 17/018,268

(22) Filed: Sep. 11, 2020

Related U.S. Application Data
(60) Provisional application No. 62/900,039, filed on Sep. 13, 2019.
(60) Provisional application No. 63/014,847, filed on Apr. 24, 2020.

(51) Int. Cl. C03B 17/06; C03B 23/037; C03B 23/00

(52) U.S. Cl. CPC C03B 17/067; C03B 23/0086; C03B 23/037

(57) ABSTRACT

A method of forming a glass ribbon including flowing molten glass into a sheet forming device to form formed glass. The formed glass having a first portion and a second portion, the first portion having a larger thickness than the second portion. The method further includes volumetrically heating the formed glass using an electromagnetic heating device, so that the first portion has a lower average viscosity than the second portion, and drawing the formed glass into a glass ribbon, such that the first portion is drawn with a higher rate of elongation than the second portion.

This application claims the benefit of priority under 35 U.S.C. § 119 of U.S. Provisional Application Ser. No. 62/900039 filed Sep. 13, 2019 and Provisional Application Ser. No. 63/014847 filed Apr. 24, 2020, the entire content of which is relied upon and incorporated herein by reference in its entirety.

### FIELD OF THE DISCLOSURE

The present disclosure relates generally to systems and methods for making glass ribbon and, more particularly, systems and methods for making glass ribbon with a uniform thickness using a heating device.

### BACKGROUND OF THE DISCLOSURE

In the recent decade, the demand of optical glass with high refractive index has increased with the growing market in augmented reality and virtual reality devices. Conventional methods of making optical components from glass compositions having high refractive index and low liquidus viscosities are very costly. Additionally, such conventional methods have low utilization of the molten glass borne from these methods. Typically, these methods include casting the compositions into long bars with a thickness that is significantly greater in thickness than the final end product. That is, these forming methods produce a cast bar that requires additional processing to obtain a final product form and dimensions.

The additional processing of these cast bars is often extensive. In particular, the cast bar is sawed into discs. Next, the discs are ground to polish their outer diameter to the final outer dimension of the end product. The discs are then wire sawed and subjected to grinding and polishing steps to achieve the required warp and dimensional uniformity of the end product.

### SUMMARY OF THE DISCLOSURE

The embodiments disclosed herein provide methods and systems to produce a glass ribbon with increased uniformity, while reducing manufacturing costs and waste. In particular, the methods and systems disclosed herein provide a formed glass that is volumetrically heated during a drawing step. The volumetric heating of the formed glass causes relatively thicker portions of the formed glass to be drawn with a higher rate of elongation than relatively thinner portions of the formed glass. Therefore, the relatively thicker and thinner portions are drawn into a uniform glass ribbon. The drawn glass ribbon not only has a higher rate of uniformity than when using conventional methods, but also allows more of the glass to be used in the final end product, thus reducing waste.

According to an aspect of the present disclosure, a method of forming a glass ribbon comprises flowing molten glass into a sheet forming device to form formed glass, the formed glass having a first portion and a second portion, the first portion having a larger thickness than the second portion. The method also comprises volumetrically heating the formed glass using an electromagnetic heating device so that the first portion has a lower average viscosity than the second portion. Additionally, the method comprises drawing the formed glass into a glass ribbon such that the first portion is drawn with a higher rate of elongation than the second portion

According to an aspect of the present disclosure, a glass forming system that comprises a sheet forming device configured to receive molten glass from a melting apparatus and to form formed glass, the formed glass having a first portion and a second portion, the first portion having a larger thickness than the second portion. The system also comprises an electromagnetic heating device disposed downstream of the sheet forming device along a draw pathway, the electromagnetic heating device being configured to volumetrically heat the formed glass so that the first portion of the formed glass has a lower average viscosity than the second portion of the formed glass. Additionally, the system comprises a plurality of edge rollers configured to draw the formed glass into a glass ribbon such that a thickness of the first portion of the formed glass is substantially equal to a thickness of the second portion of the formed glass in the glass ribbon.

Additional features and advantages will be set forth in the detailed description which follows, and will be readily apparent to those skilled in the art from that description or recognized by practicing the embodiments as described herein, including the detailed description which follows, the claims, as well as the appended drawings.

It is to be understood that both the foregoing general description and the following detailed description describe various embodiments and are intended to provide an overview or framework to understanding the nature and character of the claimed subject matter.

The accompanying drawings are included to provide a further understanding of the various embodiments, and are incorporated into and constitute a part of this specification. The drawings illustrate the various embodiments described herein, and together with the description serve to explain the principles and operation of the claimed subject matter.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is a flow chart depicting a method of making a glass ribbon, according to embodiments of the present disclosure;

FIG. 2 is a schematic side view of an embodiment of a glass forming system, according to embodiments of the present disclosure;

FIG. 3 is a schematic front view of the glass forming system of FIG. 2, according to embodiments of the present disclosure;

FIG. 4 is a cross-sectional view of the glass forming system of FIG. 3 taken along line A-A of FIG. 3, according to embodiments of the present disclosure;

FIG. 5 is a partial view of a formed glass undergoing a heating process, according to embodiments of the present disclosure;

FIG. 6 graphically depicts temperature profiles as a function of time while volumetrically heating the formed glass, according to embodiments of the present disclosure; and

FIGS. 7-9 graphically depict volume loss density profiles across the thickness of the formed glass, according to embodiments of the present disclosure.

### DETAILED DESCRIPTION

In the embodiments described herein, continuous cast and draw methods for forming glass ribbon with decreased thickness variation is disclosed. The glass ribbon formed using the embodiments described herein may be used to form low viscosity glass compositions, such as those useful for augmented and/or virtual reality displays. The continuous cast and draw methods described herein include flowing a molten glass into a sheet forming device to form a formed glass, cooling the formed glass in the sheet forming device, conveying the formed glass from the sheet forming device, and heating and drawing the formed glass into a thin glass ribbon. The continuous cast and draw methods described herein enable mass production of the display glass for augmented and/or virtual reality applications at a lower cost. The produced glass ribbon has high uniformity, high dimensional stability, and low warpage. Accordingly, the produced glass ribbon requires limited post-processing, thus lowering manufacturing cost and reducing waste. Various embodiments of processes and systems for forming glass ribbons will be described herein with specific references to the appended drawings.

As used herein, the term “upper liquidus viscosity” refers to the viscosity of the glass employed in the articles and methods of the disclosure at which the glass forms a homogenous melt with no crystals. As also used herein, the term “lower liquidus viscosity” refers to the viscosity of the glass employed in the articles and methods of the disclosure at which the glass can be susceptible to the growth of one or more crystalline phases.

As used herein the “devitrification zone” of the glass employed in the articles and methods of the disclosure is the temperature range given by the upper liquidus temperature to the lower liquidus temperature, e.g., the temperature range in which the glass experiences crystal growth of one or more crystalline phases above 0.01 μm/min.

As used herein, the “average viscosity” of the glass employed in the articles and methods of the disclosure refers to the viscosity of the glass, glass ribbon, glass sheet or other article of the disclosure, as measured during the referenced process or method step (e.g., drawing) over a region of the article and over a time duration sufficient to ascertain an average viscosity value according to analytical and measurement methods understood by those of ordinary skill in the field of the disclosure. Viscosity and average viscosity, as used herein, are determined by first using an ASTM standard (C-695) lab measurement using a rotating crucible containing molten glass and a spindle with a thermocouple immersed in the glass. The ASTM standard (C-695) lab measurement measures the glass viscosity at different glass temperatures. Then, during the casting step (i.e., the step of cooling the molten glass as it flows through a caster) of the method described herein, glass temperature is measured using thermocouples located in both the glass and in the caster (e.g., 50 total thermocouples). The measured temperatures may then be used to determine the corresponding viscosity, such as average viscosity, using the lab measurement data from the ASTM standard (C-695) lab measurement. Moreover, as thermocouples are located both in the caster and in the glass, these thermocouples may be used to measure the temperature of the glass at the major surfaces of the glass and through the thickness of the glass, for example, the temperature of a central region of the glass.

As used herein, the term “continuous” refers to the methods and processes of the disclosure that are configured to form glass sheet, ribbon and other articles without the need for any intermediate and/or post-cooling thermal processing, such as annealing or re-drawing. Put another way, the processes and methods of the disclosure are configured to form glass sheets, glass ribbons, and other articles that are not cut or sectioned prior to its drawing step.

As used herein, the “thickness variation” of the glass wafer, glass ribbon, glass sheet or other article of the disclosure is measured by determining the difference between the minimum and maximum thickness of the glass wafer, glass ribbon, glass sheet, or other article by a mechanical contact caliper or micrometer, or a non-contact laser gauge for articles having a thickness of 1 mm or greater.

As used herein, the “warp” of the glass wafer, glass ribbon, glass sheet, or other article of the disclosure is measured according to the distance in between two planes containing the article, minus the average thickness of the article. Unless otherwise specified, warp as discussed herein is measured using a 3D measurement system, such as the Tropel® FlatMaster® MSP-300 Wafer Analysis System available from the Corning Tropel Corporation. For glass ribbons, glass sheets, and other glass articles of the disclosure with a substantially rectangular shape, the warp is measured according to principles understood by those of ordinary skill in the field of the disclosure. In particular, the warp is evaluated from a square measurement area with a length defined by the quality area between the beads of the article minus five (5) mm from the inner edge of each of the beads. Similarly, for glass wafers of the disclosure with a substantially circular disk-like shape, the warp is also measured according to principles understood by those of ordinary skill in the field of the disclosure. In particular, the warp is evaluated from a circular measurement area with a radius defined by the outer radius of the wafer minus five (5) mm.

As used herein, the “critical cooling rate” of the glass, glass ribbon, glass sheet or other article of the disclosure is determined by melting multiple samples of the glass, glass sheet or other article down to its glass transition temperature at various, selected cooling rates. The samples are then cross-sectioned according to standard sectioning and polishing techniques and evaluated with optical microscopy at 100× to ascertain the presence of crystals in the bulk and at its free surfaces (i.e., the top, exposed surface and the bottom surface with an interface with a crucible or the like). The critical cooling rate corresponds to the samples with the lowest cooling rate not exhibiting crystals at its surfaces and bulk.

As used herein, “upstream” and “downstream” refer to the relative position of two locations or components along a draw pathway with respect to a melting apparatus. For example, a first component is upstream from a second component if the first component is closer to the laser optics along the path traversed by the laser beam than the second component.

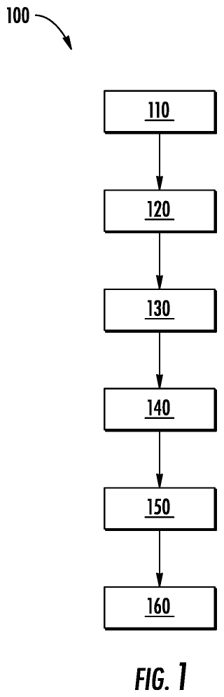

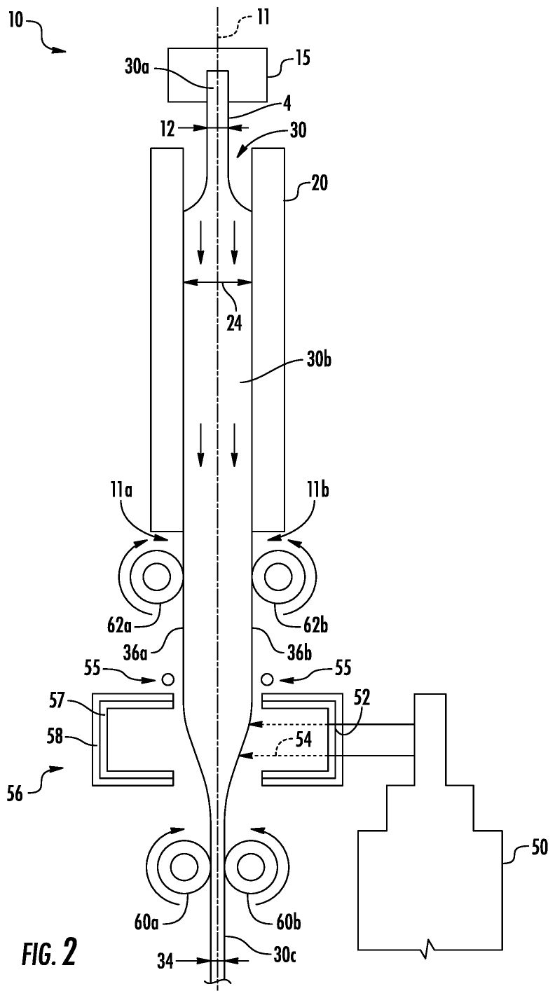

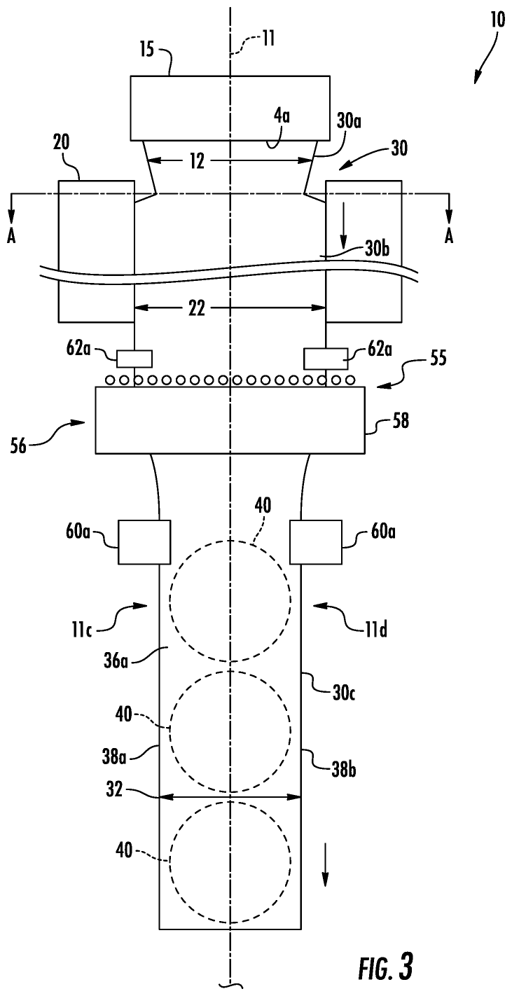

Referring now to FIGS. 1-4, a method 100 (FIG. 1) and a glass forming system 10 (FIGS. 2 and 3) for forming a glass ribbon 30c are schematically depicted. The method 100 of forming a glass ribbon 30c first comprises a step 110 of flowing a molten glass 30a from a melting apparatus 15 into a sheet forming device 20 to form a formed glass 30b, such that the molten glass 30a has a width 22 and a thickness 24. Next, at step 120, the formed glass 30b is cooled in sheet forming device 20, thus increasing the viscosity of the formed glass 30b. At step 130, the formed glass 30b is conveyed from sheet forming device 20 using one or more tractors 62a, 62b. At step 140, the formed glass 30b is volumetrically heated using a heating device 50, as discussed further below. Further, at step 150, the re-heated formed glass 30b is drawn into a glass ribbon 30c having a width 32, which is less than the width 22 of the formed glass 30b, and a thickness 34. Additionally, at step 160, the glass ribbon 30c is cooled to ambient temperature. As used herein, the width 32 and the thickness 34 of the glass ribbon 30c are measured after cooling. Thus, the glass ribbon 30c has a width 32 that is less than the width 22 of the formed glass 30b, after the glass ribbon 30c is cooled.

Glass 30 (i.e., the molten glass 30a, the formed glass 30b, and the glass ribbon 30c) may comprise a borosilicate glass, an aluminoborosilicate glass, an aluminosilicate glass, a fluorosilicate glass, a phosphosilicate glass, a fluorophosphate glass, a sulfophosphate glass, a germanate glass, a vanadate glass, a borate glass, a phosphate glass, a titanium doped silica glass, or the like. Further, the glass 30 comprises optical properties (e.g., transmissivity, refractive index, coefficient of thermal expansion, etc.) suitable for optical components, such as display glass of augmented reality applications. As one example, the composition of the glass 30 may comprise 40.2 mol % SiO₂, 2.4 mol % B₂O₃; 11.3 mol % Li₂O; 22.9 mol % CaO; 5.4 mol % La₂O₃; 3.8 mol % ZrO₂, 4.8 mol % Nb₂O₅, and 9.3 mol % TiO₂. As another example, the composition of the glass 30 may comprise 42.7 mol % SiO₂; 3.9 mol % B₂O₃; 4.7 mol % BaO; 26.6 mol % CaO; 4.5 mol % La₂O₃; 2.2 mol % ZrO₂; 6.1 mol % Nb₂O₅; and 9.3 mol % TiO₂.

The glass 30 may be derived from a glass composition having a refractive index from 1.5 to 2.1, such as from 1.6 to 2.0, from 1.6 to 1.9, from 1.65 to 1.9, from 1.7 to 1.85, or from 1.6 to 1.8, for example, 1.5, 1.6, 1.65, 1.7, 1.75, 1.8, 2, 2.1, or any range having any two of these values as endpoints, or any open-ended range having any of these values as a lower or upper bound. The glass 30 may comprise an upper liquidus viscosity from 50000 Poise or less, such as from to 50000 Poise to 1 Poise, 5×10⁵ Poise or less, 1×10⁵ Poise or less, 5×10⁴ Poise or less, 1×10⁴ Poise or less, 5×10³ Poise or less, 1×10³ Poise or less, 5×10² Poise or less, 100 Poise or less, 50 Poise or less, 40 Poise or less, 30 Poise or less, 20 Poise or less, 10 Poise or less, or any range having any two of these values as endpoints.

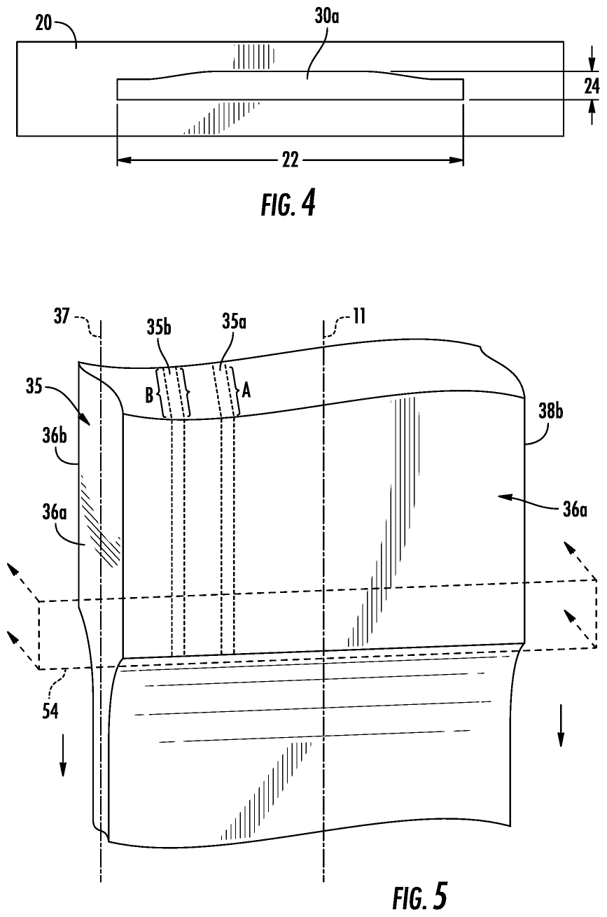

Referring now to FIGS. 2-5, as discussed above, glass forming system 10 comprises melting apparatus 15, sheet forming device 20 (a cross section of which is depicted in FIG. 4), tractors 62a, 62b, and heating device 50. Glass forming system 10 also comprises edge rollers 60a, 60b, which apply a pulling force to the formed glass 30b during the drawing process. The glass 30 travels along a draw pathway 11 within glass forming system 10. Draw pathway 11 includes a first side 11a opposite a second side 11b (each shown in FIG. 2) and a first edge 11c opposite a second edge 11d (each shown in FIG. 3). When the glass 30 is traveling along draw pathway 11, the first side 11a of the draw pathway 11 faces a first major surface 36a (first outer surface) of the glass 30, the second side 11b of the draw pathway 11 faces a second major surface 36b (second outer surface) of the glass 30, the first edge 11c of the draw pathway 11 faces a first edge surface 38a (third outer surface) of the glass 30, and the second edge 11d of the draw pathway 11 faces a second edge surface 38b (fourth outer surface) of the glass 30.

As shown in FIGS. 2 and 3, sheet forming device 20 is disposed downstream of melting apparatus 15 so that, in operation, the molten glass 30a flows from melting apparatus 15 along draw pathway 11 and into sheet forming device 20. It is contemplated that sheet forming device 20 can be of varied construction, e.g., of various materials with or without additional cooling capabilities, as understood by those of ordinary skill in the art, provided that sheet forming device 20 is capable of cooling the molten glass 30a (which becomes the formed glass 30b) through its devitrification zone. In some embodiments, the width of sheet forming device 20 is from 100 mm to 5 m, for example, from 200 mm to 5 m, from 250 mm to 5 m, from 300 mm to 5 m, from 350 mm to 5 m, from 400 mm to 5 m, from 450 mm to 5 m, from 500 mm to 5 m, from 100 mm to 4 m, from 100 mm to 3 m, from 100 mm to 2 m, from 100 mm to 1 m, from 100 mm to 0.9 m, from 100 mm to 0.8 m, from 100 mm to 0.7 m, from 100 mm to 0.6 m, from 100 mm to 0.5 m, such as 100 mm, 250 mm, 500 mm, 750 mm, 1 m, 2 m, 5 m, or any range having any two of these values as endpoints, or any open-ended range having any of these values as a lower or upper bound. In some embodiments, the thickness of the sheet forming device 20 is from 1 mm to 500 mm, such as 2 mm to 250 mm, 5 mm to 100 mm, 10 mm to 50 mm, or the like, for example 1 mm or greater, 2 mm or greater, 3 mm or greater, 4 mm or greater, 5 mm or greater, 7 mm or greater, 8 mm or greater, 9 mm or greater, 10 mm or greater, 15 mm or greater, 20 mm or greater, 25 mm or greater, 30 mm or greater, 35 mm or greater, 40 mm or greater, 45 mm or greater, 50 mm or greater, any thickness up to 500 mm, or any range having any two of these values as endpoints. Furthermore, the width 22 of the formed glass 30b may be the width of sheet forming device 20, and the thickness 24 of the formed glass 30b may be the thickness of sheet forming device 20.

Sheet forming device 20 is schematically depicted in FIGS. 2 and 3 to show the formed glass 30b positioned in sheet forming device 20, however, it should be understood that while sheet forming device 20 has open ends, such that the formed glass 30b can travel through sheet forming device 20, the sides of sheet forming device 20 form a continuous structure, as shown in FIG. 4.

In some embodiments, sheet forming device 20 comprises a caster. However, it is also contemplated that sheet forming device 20 can be replaced with, for example, a fusion drawing device or a rolling device. Thus, heating device 50, as discussed further below, is not limited to use with sheet forming device 20 and may be used with other known glass drawing devices and systems.

Referring again to FIGS. 2 and 3, heating device 50 comprises a beam outlet 52 that is disposed downstream from sheet forming device 20 along draw pathway 11. Beam outlet 52 is configured to volumetrically heat glass conveyed along draw pathway 11 with electromagnetic radiation. As used herein, “volumetric heating” refers to heating the volume of a material (such as the glass 30) such that the electromagnetic radiation uniformly penetrates throughout the volume of the material. Thus, volumetric heating delivers energy evenly into the body of the material. In contrast, traditional conduction and convection thermal heating relies on surface temperature heating of the material. Therefore, with the traditional conduction and convection heating, the surface temperature of the material (such as the glass 30) rises much faster than the interior of the material.

As discussed above, heating device 50 is an electromagnetic heating device that uses electromagnetic radiation to volumetrically heat formed glass 30b. In some embodiments, the electromagnetic radiation may be microwaves so that heating device 50 is a gyrotron microwave heating device. In other embodiments, the electromagnetic radiation may be infrared waves so that heating device 50 is an infrared heating device. It is also contemplated that the electromagnetic radiation is visible light, ultraviolet light, or any other radiation configured to heat the volume of the glass 30.

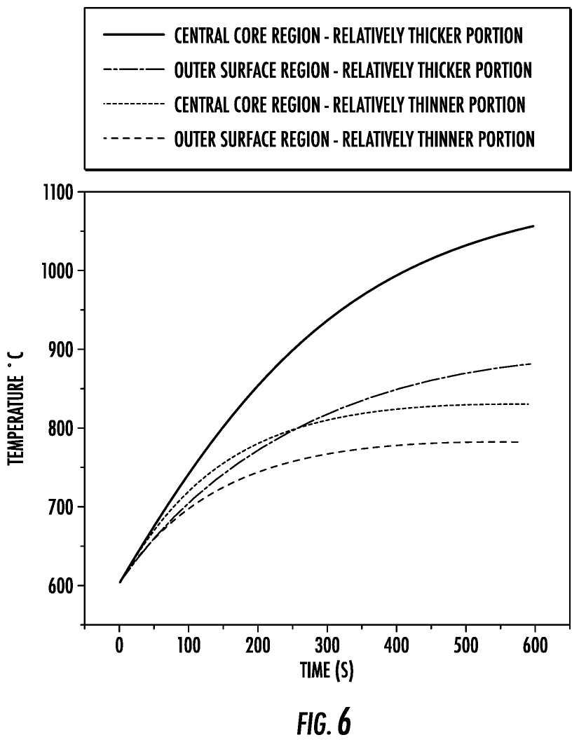

In some embodiments, heating device 50 comprises a high power linear-beam vacuum tube, which generates millimeter-wave electromagnetic waves by the cyclotron resonance of electrons in a strong magnetic field. In some embodiments, the electromagnetic radiation generated by heating device 50 comprises microwave beam 54, and heating device 50 directs microwave beam 54 outward from beam outlet 52 towards a major surface of the formed glass 30b, such as the first major surface 36a or the second major surface 36b of the glass 30. As shown in FIG. 2, beam outlet 52 is disposed on second side 11b of draw pathway 11, such that beam outlet 52 directs microwave beam 54 towards the second major surface 36b, but it should be understood that beam outlet 52 may be disposed on first side 11a of draw pathway 11. As also shown in FIG. 5, microwave beam 54 can be focused by heating device 50 into a stripe shape. In some examples, a cross section of microwave beam 54 comprises a width that is equal to or greater than the width of sheet forming device 20 to facilitate short heating times and fast heating rates.

The electromagnetic radiation generated by heating device 50 may comprise a power intensity of about 1×10⁵ W/m² or greater, about 1×10⁶ W/m² or greater, about 2×10⁶ W/m² or greater, about 3×10⁶ W/m² or greater, about 4×10⁶ W/m² or greater, about 5×10⁶ W/m² or greater, about 6×10⁶ W/m² or greater, about 7×10⁶ W/m² or greater, about 8×10⁶ W/m² or greater, about 9×10⁶ W/m² or greater, about 1×10⁷ W/m² or greater, about 1×10⁸ W/m² or greater, or any range having any two of these values as endpoints, for example, a power intensity in the range of about 1×10⁵ W/m² to about 1×10⁸ W/m², about 2×10⁶ W/m² to about 9×10⁶ W/m², or about 6×10⁶ W/m² to about 8×10⁶ W/m². In addition, the electromagnetic radiation generated by heating device 50 may comprise a frequency of about 5 GHz to about 500 GHz, about 5 GHz to about 400 GHz, about 5 GHz to about 300 GHz, about 10 GHz to about 300 GHz, about 10 GHz to about 200 GHz, about 25 GHz to about 200 GHz, about 28 GHz to about 300 GHz, about 50 GHz to about 200 GHz, for example, about 5 GHz, about 25 GHz, about 50 GHz, about 75 GHz, about 100 GHz, about 150 GHz, about 200 GHz, about 300 GHz, about 400 GHz, about 500 GHz, or any range having any two of these values as endpoints, or any open-ended range having any of these values as a lower or upper bound.

While a single heating device 50 is depicted in FIG. 2, it is also contemplated that more than one heating device may be used. For example, glass forming system 10 may comprise a first heating device having a beam outlet disposed on the first side 11a of draw pathway 11 and a second heating device having a beam outlet disposed on the second side 11b of draw pathway 11. In this embodiment, the electromagnetic radiation (e.g., microwave beams 54) may be directed towards both the first major surface 36a and the second major surface 36b of the cast glass 30b.

Referring again to FIGS. 2 and 3, glass forming system 10 may further include a control structure 56, which comprises an absorbing device 57, a shielding device 58, or both. For example, in the embodiment depicted in FIGS. 2 and 3, control structure 56 comprises absorbing device 57 surrounded by shielding device 58. In some embodiments, shielding device 58 comprises a metal material, such as stainless steel, to reduce and/or prevent any electromagnetic leakage, such as microwave leakage. Absorbing device 57 may comprise, for example, carbon-based foam absorbers, a water jacket, or combinations thereof, to absorb electromagnetic radiation, thereby reducing and/or preventing any electromagnetic leakage, such as microwave leakage. In addition, beam outlet 52 of heating device 50 may extend into control structure 56 such that, for example, the microwave beam 54 is contained within control structure 56, which helps direct microwave beam 54 toward draw pathway 11 and minimizes electromagnetic propagation away from draw pathway 11 and out of control structure 56. For example, control structure 56 may comprise a hole into which (or through which) beam outlet 52 extends or is otherwise coupled.

Control structure 56 is schematically depicted in FIGS. 2 and 3 to show the formed glass 30b positioned in control structure 56. However, it should be understood that, while control structure 56 has open ends, such that the formed glass 30b can flow through control structure 56, the sides of control structure 56 may form a continuous structure.

As depicted in FIGS. 2 and 3, some embodiments of glass forming system 10 comprise one or more secondary heating devices 55, which may assist in the heating step 140. Secondary heating devices 55 may be disposed upstream of beam outlet 52 along draw pathway 11. For example, secondary heating devices 55 may be disposed along the first side 11a and the second side 11b of draw pathway 11. The plurality of secondary heating devices 55 may comprise one or more conduction heaters, convection heaters, infrared heaters, resistance heaters, induction heaters, flame heaters, or the like. Secondary heating device 55 are configured to simultaneously heat the formed glass 30b during the volumetric heating by heating device 50.

Further, edge rollers 60a, 60b are disposed downstream beam outlet 52 of heating device 50. Edge roller 60a is disposed on the first side 11a of draw pathway 11 and edge roller 60b disposed on the second side 11b of draw pathway 11. In operation, edge roller 60a engages the first major surface 36a of the formed glass 30b, edge roller 60b engages the second major surface 36b of formed cast glass 30b, and edge rollers 60a, 60b together rotate to apply a pulling force to the formed glass 30b, thereby drawing the formed glass 30b into the glass ribbon 30c.

Tractors 62a, 62b are disposed between sheet forming device 20 and beam outlet 52. As shown in FIG. 2, tractors 62a, 62b include rollers for controlling the velocity of the formed glass 30b as it travels through and exits sheet forming device 20.

Referring now to FIGS. 2 and 3, in some embodiments, melting apparatus 15 comprises a melter such that an exit 4 of melting apparatus is an orifice 4a that distributes the molten glass 30a as it leaves melting apparatus 15. Orifice 4a comprises a maximum dimension 12, which may be 5 m or less. The maximum dimension 12 of orifice 4a can be less than or equal to the width of sheet forming device 20. Depending on the viscosity of the molten glass 30a flowing from melting apparatus 15, the width of sheet forming device 20 can have a width that is the same as, or smaller than, the maximum dimension 12 of orifice 4a. As such, the maximum dimension 12 of orifice 4a can be less than or equal to the width of sheet forming device 20. In other embodiments, the maximum dimension 12 of orifice 4a can be larger than the width of sheet forming device 20, e.g., for compositions of the molten glass 30a that are relatively low in upper liquidus viscosity (e.g., 5 Poise to 50000 Poise). In particular, these glasses upon melting (i.e., the molten glass 30a) can ‘neck’ as they leave orifice 4a of melting apparatus 15, allowing them to flow into a sheet forming device 20 having a width that is smaller in dimension than the maximum dimension 12 of orifice 4a of melting apparatus 15. In other embodiments, the width of sheet forming device 20 may be greater than or equal to the maximum dimension 12 of exit 4.

Referring now to FIGS. 1-5, the method 100 will now be described in more detail. At step 110, melting apparatus 15 delivers the molten glass 30a to sheet forming device 20 via exit 4. During step 110, the molten glass 30a flows from melting apparatus 15 at a temperature of about 1000° C. or greater, for example, at a temperature from about 1000° C. to about 1500° C., such as from about 1000° C. to about 1400° C., from about 1000° C. to about 1300° C., from about 1000° C. to about 1250° C., from about 1000° C. to about 1200° C., from about 1000° C. to about 1150° C., for example, about 1000° C., about 1050° C., about 1100° C., about 1150° C., about 1200° C., about 1300° C., about 1400° C., about 1500° C., or any range having any two of these values as endpoints, or any open-ended range having any of these values as a lower or upper bound. Further, the molten glass 30a may comprise a viscosity of from about 10 Poise to about 100,000 Poise as it flows from melting apparatus 15, such as from about 10 Poise to about 50,000 Poise, for example, about 5×10⁴ Poise or less, about 1×10⁴ Poise or less, about 5×10³ Poise or less, about 1×10³ Poise or less, about 5×10² Poise or less, about 100 Poise or less, about 50 Poise or less, about 40 Poise or less, about 30 Poise or less, about 20 Poise or less, about 10 Poise or less, or any range having any two of these values as endpoints.

Next, step 120 includes cooling the molten glass 30a in sheet forming device 20 to form the formed glass 30b. Without intending to be limited by theory, cooling the molten glass 30a into the formed glass 30b minimizes the formation of crystals in the formed glass 30b and the resultant glass ribbon 30c. Sheet forming device 20 cools the molten glass 30a into the formed glass 30b having a viscosity of about 10⁸ Poise or more, for example, about 5×10⁸ Poise or more, about 10⁹ Poise or more, about 5×10⁹ Poise or more, about 10¹⁰ Poise or more, about 5×10¹⁰ Poise, or any range having any two of these values as endpoints. In addition, sheet forming device 20 cools the molten glass 30a into the formed glass 30b, which is at temperature of about 50° C. or greater, or about 100° C. or greater, or about 150° C. or greater, or about 200° C. or greater, or about 250° C. or greater, or about 300° C. or greater, or about 350° C. or greater, or about 400° C. or greater, or about 450° C. or greater, or about 500° C. or greater, or about 550° C. or greater, or about 600° C. or greater, or about 650° C. or greater, or about 700° C. or greater, and all temperature values between these minimum threshold levels, such as a range from about 50° C. to about 1500° C., about 200° C. to about 1400° C., about 400° C. to about 1200° C., about 600° C. to about 1150° C., or any range having any two of these values as endpoints or any open-ended range having any of these values as a lower bound. The cooling step 120 is conducted in a fashion to ensure that the formed glass 30b does not fall below 50° C., to ensure that the method 100 can remain continuous in view of the additional heating that occurs during the subsequent conveying step 130, heating step 140, and drawing step 150, respectively. Further, sheet forming device 20 cools the molten glass 30a into the formed glass 30b having a temperature at or above a critical cooling rate for the formed glass 30b (and no lower than 50° C.).

When cooling the formed glass 30b in sheet forming device 20, the maximum growth rate of any crystalline phase is 10 μm/min or less from the upper liquidus viscosity to the lower liquidus viscosity of the glass 30 (also referred to herein as the “devitrification zone”), for example, 9 μm/min or less, 8 μm/min or less, 7 μm/min or less, 6 μm/min or less, 5 μm/min or less, 4 μm/min or less, 3 μm/min or less, 2 μm/min or less, 1 μm/min or less, 0.5 μm/min or less, 0.1 μm/min or less, 0.01 μm/min or less, for example, from 0.01 μm/min to 10 μm/min, from 0.01 μm/min to 5 μm/min, from 0.01 μm/min to 2 μm/min, from 0.01 μm/min to 1 μm/min, from 0.1 μm/min to 1 μm/min, from 0.01 μm/min to 0.5 μm/min, or any range having any two of these values as endpoints, or any open-ended range having any of these values as an upper bound.

Referring still to FIGS. 1-5, during the conveying step 130, the formed glass 30b is conveyed from sheet forming device 20 using tractors 62a, 62b. In operation, the formed glass 30b can be moved or otherwise conveyed during step 130 by tractors 62a, 62b from the end of sheet forming device 20 toward heating device 50 and edge rollers 60a, 60b. In operation, tractors 62a, 62b may control the velocity of the formed glass 30b such that the flow rate of the formed glass 30b varies by 1% or less. In some embodiments, when conveyed from sheet forming device 20, the formed glass 30b comprises a thickness of about 1 mm or greater, about 1.5 mm or greater, about 2 mm or greater, about 3 mm or greater, about 4 mm or greater, about 8 mm or greater, about 10 mm or greater, about 12 mm or greater, about 15 mm or greater, about 20 mm or greater, about 25 mm or greater, or the like, such as about 1 mm to about 30 mm, about 2 mm to about 25 mm, about 5 mm to about 20 mm, or any range having any two of these values as endpoints, or any open-ended range having any of these values as a lower bound.

Referring still to FIGS. 1-5, the heating step 140 comprises volumetrically heating the formed glass 30b using heating device 50. In some embodiments, the heating step 140 comprises volumetrically heating the formed glass 30b using heating device 50 and heating the formed glass using one or more secondary heaters 55. It is also contemplated, as discussed further below, that heating step 140 comprises cooling one or more portions of the formed glass 30b while heating the formed glass with heating device 50 and/or secondary heaters 55.

FIG. 5 depicts a portion of the formed glass 30b undergoing volumetric heating. As discussed above, the formed glass 30b comprises the first major surface 36a and the second major surface 36b. The first major surface 36a is opposite the second major surface 36b such that a glass body 35 extends from the first major surface 36a to the second major surface 36b. Furthermore, a central region 37 is disposed in the glass body 35 equidistant from the first major surface 36a and the second major surface 36b. Because the heating step 140 relies on volumetric heating, central region 37 of the cast glass 30b heats uniformly with or faster than the first major surface 36a and the second major surface 36b of the formed glass 30b. Thus, as also discussed further below, a temperature of central region 37 of the formed glass 30b is equal to or greater than a temperature of the first major surface 36a of the formed glass 30b and a temperature of the second major surface 36b of the formed glass 30b.

As shown in FIG. 5, glass body 35 comprises a first portion 35a with a relatively larger thickness (thickness A) and a second portion 35b with a relatively smaller thickness (thickness B). Thus, first portion 35a has a larger thickness than second portion 35b (i.e., A>B). First portion 35a and second portion 35b may have the same width. It is also noted that glass body 35 may comprise one or more first portions 35a and/or second portions 36b along its width. The one or more first portions 35a may have different thicknesses from each other, and the one or more second portions 35b may have different thicknesses from each other.

In some embodiments, the average thickness of first portion 35a and second portion 35b are each in a range from about 1.0 mm to about 35.0 mm, or about 10.0 mm to about 28.0 mm, or about 12.0 mm to about 26.0 mm, such that first portion 35a has a larger average thickness than second portion 35b. For example, first portion 35a has an average thickness of 12.5 mm and second portion 35b has an average thickness of 12.0 mm. In another example, first portion 35a has an average thickness of 25.1 mm and second portion 35b has an average thickness of 25.0 mm.

Without intending to be limited by theory, volumetrically heating glass body 35 with heating device 50 causes the relatively thicker first portion 35a to absorb and retain more electromagnetic radiation than the relatively thinner second portion 35b, due to its larger size. Accordingly, volumetrically heating glass body 30 causes an internal temperature of glass body 35 (for example, a temperature along central region 37) to be higher in first portion 35a than in second portion 35b. Thus, a temperature of central region 37 in first portion 35a is greater than a temperature of central region 37 in second portion 35b. The increased internal temperature in first portion 35a lowers the average viscosity of the glass in first portion 35a compared to the glass in second portion 35b, so that first portion 35a is drawn with a higher rate of elongation than second portion 35b. More specifically, and as discussed further below, because first portion 35a has a lower average viscosity than second portion 35b, when drawn by edge roller 60a, 60b, first portion 35a is drawn with a higher rate of elongation than second portion 30b. Therefore, first portion 35a is able to stretch to the same desired thickness as second portion 35b to produce a uniform glass thickness.

For example, during the volumetric heating, the temperature of central region 37 in first portion 35a is about 2% or greater, about 5% or greater, about 10% or greater, about 15% or greater, about 20% or greater, about 25% or greater, or about 30% or greater than the temperature of central region 37 in second portion 35b. In some embodiments, during the volumetric heating, the temperature of central region 37 in first portion 35a is about 670° C. or greater, about 680° C. or greater, about 690° C. or greater, about 700° C. or greater, about 710° C. or greater, about 720° C. or greater, about 730° C. or greater, about 740° C. or greater, about 750° C. or greater, about 760° C. or greater, about 770° C. or greater, about 780° C. or greater, about 790° C. or greater, about 800° C. or greater, about 810° C. or greater, about 820° C., about 830° C. or greater, about 840° C. or greater, about 850° C. or greater, about 860° C. or greater, about 870° C. or greater, about 880° C. or greater, about 890° C. or greater, or about 900° C. or greater, such as from about 670° C. to about 900° C., from about 700° C. to about 900°, from about 700° C. to about 875° C., from about 700° C. to about 850° C., from about 720° C. to about 820° C., from about 720° C. to about 800° C., from about 720° C. to about 775° C., or any range having any two of these values as endpoints, or any open-ended range having any of these values as a lower bound. Additionally or alternatively, during the volumetric heating, the temperature of central region 37 in second portion is about 760° C. or less, about 750° C. or less, about 740° C. or less, about 720° C. or less, about 710° C. or less, about 700° C. or less, about 690° C. or less, about 680° C. or less, about 670° C. or less, about 660° C. or less, or about 650° C. or less, such as from about 680° C. to about 740° C., from about 690° C. to about 720° C., or from about 700° C. to about 720° C.

As discussed above, volumetrically heating the formed glass 30b causes the central region 37 of first portion 35a to have a higher temperature than the central region 37 of second portion 35b. However, it is also contemplated, in some embodiments, that the volumetrically heating may cause, for example, first major surface 36a or second major surface 36b to have a higher temperature in first portion 35a than in second portion 35b. Thus, the highest temperature in first and second portions 35a, 35b need not necessarily be along center region 37.

Further, during the volumetric heating, the formed glass 30b is heated so that a ratio of the average viscosity of first portion 35a compared to second portion 35b is in a range of about 0.1 to about 0.8, about 0.2 to about 0.7, about 0.3 to about 0.6, about 0.4 to about 0.5. In some embodiments, first portion 35a is heated to an average viscosity of about 10⁷ Poise or less, about 10⁶ Poise or less, about 5×10⁵ Poise or less, about 10⁴ Poise or less, about 5×10³ Poise or less, about 10³ Poise or less, or any range having any two of these values as endpoints. In some embodiments, the average viscosity of central portion 37 in first portion 35a is in a range of about 50 k Poise to about 10⁷ Poise.

During the volumetric heating, second portion 35b of the formed glass 30b is heated to an average viscosity of about 10⁸ Poise or less, about 10⁷ Poise or less, about 10⁶ Poise or less, about 5×10⁵ Poise or less, or any range having any two of these values as endpoints.

As discussed above, heating device 50 volumetrically heats the formed glass 30b so that first portion 35a assumes a higher temperature than second portion 35b, causing first portion 35a to be drawn with a higher rate of elongation than second portion 35b. In some embodiments, the rate of elongation of first portion 35a is about 2× or higher, about 3× or higher, about 4× or higher, or about 5× or higher than the rate of elongation of second portion 35a.

It is also contemplated that in addition to the volumetric heating from heating device 50, the formed glass 30b may also be cooled in order to provide the uniform thickness of the drawn glass ribbon 30c. For example, second portion 35b of the formed glass 30b may be cooled in order to increase its average viscosity. Such cooling may be provided by radiative or convective cooling. In some embodiments, the formed glass 30b may be cooled without any volumetric heating, in order to increase the average viscosity of one or more portions (e.g., second portion 35b) of the formed glass 30b. Thus, these portions will be drawn with a lower rate of elongation than the remainder of the formed glass 30b in order to provide the uniformly drawn glass ribbon 30c.

FIG. 6 shows a temperature profile across the thickness of an exemplary formed glass as a function of time. The exemplary formed glass has an average thickness of 25 mm and was volumetrically heated using heating device 50 with a power intensity of 1×10⁵ W/m² for a total time of 600 seconds. During the volumetric heating, the exemplary formed glass was also heated in a 600° C. furnace. While thermocouples may be used to determine the temperature of the glass at the major surfaces and throughout the thickness of the glass (i.e., determine glass volumetric temperature distribution), the temperature profile depicted in FIG. 6 was determined from math modeling results. The exemplary formed glass of FIG. 6 comprises a relatively thicker portion and a relatively thinner portion, as discussed above.

FIG. 6 shows that a central core region of the relatively thicker portion of the glass reached a higher temperature during the volumetric heating than an outer surface region of the relatively thicker portion of the glass. Similarly, FIG. 6 shows that a central core region of the relatively thinner portion of the glass reached a higher temperature during the volumetric heating than an outer surface region of the relatively thinner portion of the glass. Thus, the volumetric heating caused the central core regions of each of the thicker and thinner portions to reach a higher temperature than the outer surface regions. Additionally, as also shown in FIG. 6, these central core regions had faster heating rates than the outer surface regions.

FIG. 6 also shows that, due to the volumetric heating, both the central core region and the outer surface region of the relatively thicker portion reached a higher temperature than either of the central core region or the outer surface region of the relatively thinner portion. Therefore, the viscosity of the relatively thicker portion is less than the viscosity of the relatively thinner portion, which helps to provide the uniformly drawn glass as discussed above.

While not intending to be limited by theory, while heating the formed glass 30b to a high enough temperature to reach a sufficiently low viscosity (to facilitate drawing the formed glass 30b into glass ribbon 30c), it may be advantageous to minimize the heating period to minimize and/or prevent crystallization. Because volumetric heating increases the temperature of the glass at a faster rate than conventional conduction and convection heating techniques, volumetric heating, as disclosed herein, may require reduced heating periods to reach the desired temperatures and viscosities. For example, during the volumetric heating using heating device 50, the temperature of the formed glass 30b in first portion 35a increases at an average heating rate of about 5° C./second or greater, about 10° C./second or greater, about 15° C./second or greater, about 20° C./second or greater, about 30° C./second or greater, about 40° C./second or greater, about 50° C./second or greater, about 60° C./second or greater, about 70° C./second or greater, about 80° C./second or greater, about 90° C./second or greater, about 100° C./second or greater, such as about 5° C./second to about 100° C./second, about 10° C./second to about 90° C./second, about 20° C./second to about 80° C./second, about 30° C./second to about 80° C./second, about 40° C./second to about 80° C./second, about 50° C./second to about 80° C./second, or any range having any two of these values as endpoints. During the volumetric heating, the temperature of the formed glass 30b in second portion 35b may increase at an average heating rate less than the heating rate of first portion 35a. For example, the average heating rate may be about 0.3, or about 0.4, or about 0.5, or about 0.6, or about 0.7, or about 0.8, or about 0.9 times less than the average heating rate of first portion 35a.

The central region 37 of the formed glass 30b in both first and second portions 35a, 35b may be heated to the above-disclosed temperatures in a heating period of about 0.1 seconds to about 30 seconds, about 0.1 seconds to about 20 seconds, about 0.1 seconds to about 10 seconds, about 0.1 seconds to about 7.5 seconds, about 0.5 seconds to about 7.5 seconds, about 1 second to about 7.5 seconds, about 1.5 seconds to about 6 seconds, about 1.5 seconds to about 5 seconds, about 0.5 seconds to about 5 seconds, or any range having any two of these values as endpoints, or any open-ended range having any of these values as a lower or upper bound.

As discussed above, method 100 comprises heating a formed glass 30b so that a relatively thicker portion (i.e., first portion 35a) is heated to a higher temperature and, therefore, has a lower average viscosity than a relatively thinner portion (i.e., second portion 35b) of the glass. Due to its lower viscosity, first portion 35a is drawn with a relatively higher rate of elongation than second portion 35b. Thus, when formed glass 30b is pulled downward, as shown in FIG. 2, by edge rollers 60a, 60b, first portion 35a is drawn into glass ribbon 30c with relatively higher rate of elongation than second portion 35b. As shown in FIG. 5, first portion 35a initially comprises a greater thickness than second portion 35b. However, first portion 35a is drawn with a higher rate of elongation than second portion 35b so that both first and second portions 35a, 35b are drawn into a glass ribbon 30c with the same thickness, thus producing a uniform ribbon. Stated another way, heating the formed glass 30b with the volumetric heating lowers the viscosity of first portion 35a compared to second portion 35b, which increases its temperature and rate of elongation. Thus, first portion 35a is drawn with a higher rate of elongation than second portion 35b so that any differences in thickness in the formed glass 30b are eliminated in the drawn glass ribbon 30c.

The glass ribbon 30c formed using method 100 has a thickness variation of about 200 μm or less, about 150 μm or less, about 100 μm or less, about 75 μm or less, about 50 μm or less, about 40 μm or less, about 30 μm or less, about 20 μm or less, about 10 μm or less, about 5 μm or less, about 4 μm or less, about 3 μm or less, about 2 μm or less, about 1 μm or less, about 0.5 μm or less, or the like, such as from about 0.01 μm to about 50 μm, from about 0.01 μm to about 25 μm, from about 0.01 μm to about 10 μm, from about 0.01 μm to about 5 μm, from about 0.01 μm to about 1 μm, or any range having any two of these values as endpoints, or any open-ended range having any of these values as an upper bound. Further, the glass ribbon 30c formed using method 100 has a warp of about 500 μm or less, about 400 μm or less, about 300 μm or less, about 200 μm or less, about 150 μm or less, about 100 μm or less, about 50 μm or less, about 40 μm or less, about 30 μm or less, about 20 μm or less, about 10 μm or less, about 5 μm or less, about 0.1 μm or less, about 0.05 μm or less, or the like, such as from about 0.01 μm to about 500 μm, from about 0.01 μm to about 250 μm, from about 0.01 μm to about 100 μm, from about 0.1 μm to about 100 μm, from about 0.1 μm to about 50 μm, from about 0.1 μm to about 25 μm, from about 0.01 μm to about 25 μm, or any range having any two of these values as endpoints, or any open-ended range having any of these values as an upper bound. Moreover, the glass ribbon 30c has a surface roughness (Ra) of about 5 μm or less (as measured prior to any post-processing), for example, about 4 μm or less, about 3 μm or less, about 2 μm or less, about 1 μm or less, about 0.75 μm or less, about 0.5 μm or less, about 0.25 μm or less, about 0.1 μm or less, about 50 nm or less, about 10 nm or less, or any range having any two of these values as endpoints, or any open-ended range having any of these values as an upper bound.

As discussed above, the formed glass 30b formed using the method 100 has a higher rate of elongation in first portion 35a than in second portion 35b. In some embodiments, first portion 35a may be thicker than second portion 35b by a predefined value X, and the rate of elongation of first portion 35a may be greater than the rate of elongation of second portion 35b by the same predefined value X. For example, predefined value X may be about 1% so that first portion 35a is 1% thicker than second portion 35b and the rate of elongation of first portion 35a is 1% greater than the rate of elongation of second portion 35b. In other embodiments, the predefined value X is in a range between about 0.5% to about 50%, or about 0.75% to about 45%, or about 1.01% to about 30%, or about 1.5% to about 15%.

It is also contemplated that a frequency of the electromagnetic radiation generated from heating device 50 is correlated to a thickness of the formed glass 30b, in order to provide optimal energy absorption of the formed glass 30b. More specifically, a frequency of the electromagnetic radiation is selected to substantially match and be the same as a thickness of a selected portion of the glass (e.g., a relatively thicker portion of the glass). When the frequency matches the thickness of the selected portion of the glass, the glass absorbs the electromagnetic radiation with optimal absorption. When the frequency of the electromagnetic radiation is either above or below the thickness of the selected portion of the glass, the glass absorbs the electromagnetic radiation with an absorption rate that is below the optimal absorption.

For example, in one embodiment, the selected portion of the glass has a thickness of about 2 mm and the frequency of the electromagnetic radiation is selected to be about 2 mm or less (which is equal to about 56 GHz or higher) in order to provide the optimal energy absorption for the glass.

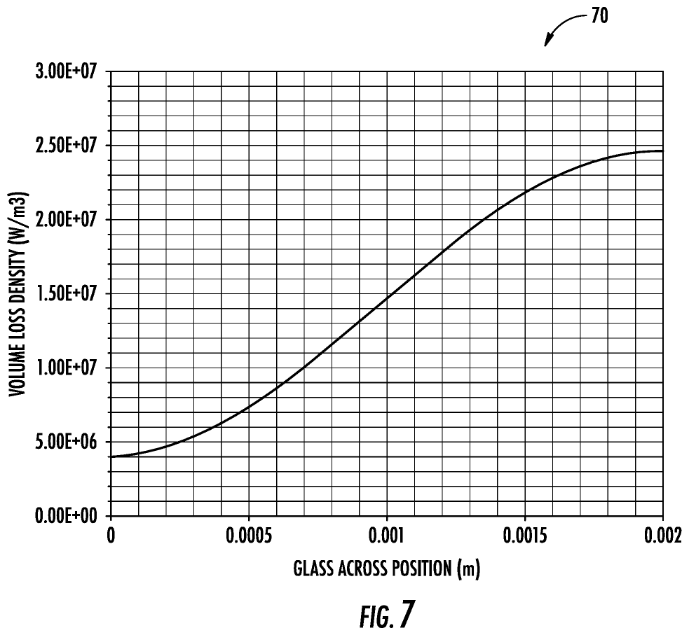

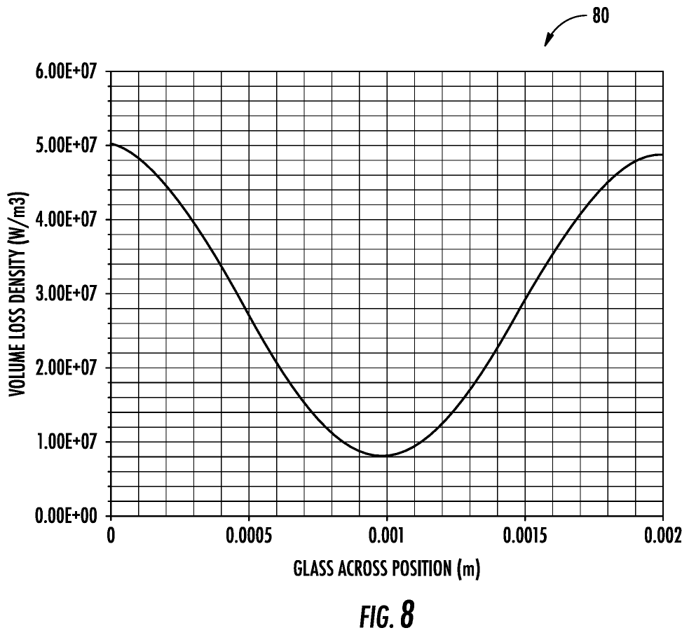

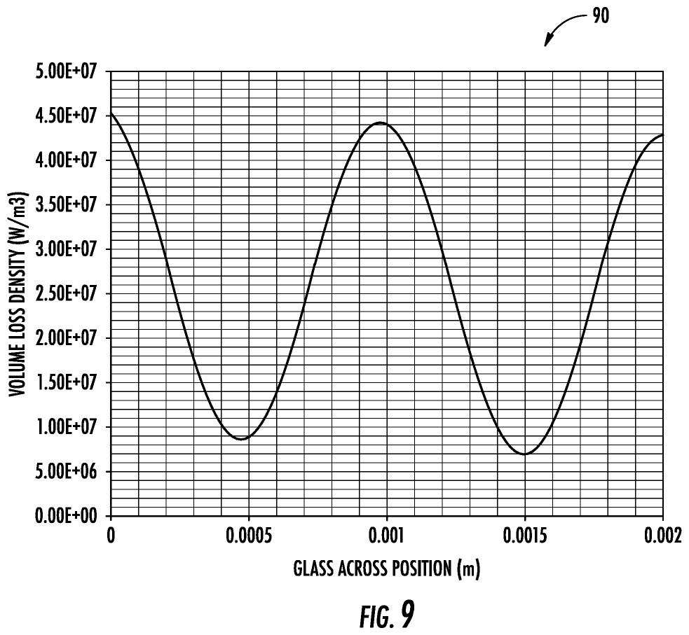

Furthermore, the heating profile of formed glass 30b may be tailored depending on the application of the glass. For example, the heating profile may be tailored so that an inner central region or an outer surface of the glass reaches the highest temperature. Depending on the heating profile of the formed glass 30b, the glass may be drawn into ribbon having different shapes. Referring now to FIGS. 7-9, graph 70 (FIG. 7), graph 80 (FIG. 8), and graph 90 (FIG. 9) are depicted, each showing the volume loss density distribution for an exemplary formed glass being volumetrically heated using heating device 50 that directs electromagnetic radiation towards at least one major surface of the exemplary formed glass. The x-axis of graphs 70, 80, and 90 each show the glass position across a 2 mm thick portion of the formed glass, and the y-axis of these graphs each show the volume loss density. The higher the volume loss density at a particular glass position across its thickness, the higher the temperature of the glass at that position, which also corresponds to a lower viscosity. As discussed above, altering the viscosity of the glass affects the rate of elongation of the drawn glass, which can change the shape (e.g., thickness) of the drawn glass. Thus, the frequency of the electromagnetic radiation may be tailored, based upon the thickness of the glass, to achieve a desired shape in the drawn glass.

For example, FIG. 7 shows an example when an asymmetric volume loss density profile is desired. Thus, in the graph of FIG. 7, the wavelength of the electromagnetic radiation is selected so that it is 4 times the thickness of the selected portion of the glass. When the selected portion of the glass has a thickness of 2 mm, for example, the frequency of the electromagnetic radiation λ=4d=8 mm, which corresponds to a frequency of 14 GHz. In graph 70 of FIG. 7, the formed glass reaches a highest temperature at its outer surface region (right side of the graph).

FIG. 8 shows an example when a parabolic volume loss density profile is selected. Thus, in the graph of FIG. 8, the wavelength of the electromagnetic radiation is selected so that it is 2 times the thickness of the selected portion of the glass. When the selected portion of the glass has a thickness of 2 mm, for example, the frequency of the electromagnetic radiation λ=2d=4 mm, which corresponds to a frequency of 28 GHz. In graph 80 of FIG. 8, the formed glass reaches a highest temperature at both its outer surface regions (right and left sides of the graph).

FIG. 9 shows an example when a sinusoidal volume loss density profile is selected. Thus, in the graph of FIG. 9, the wavelength of the electromagnetic radiation is selected so that it is equal to the thickness of the selected portion of the glass. When the selected portion of the glass has a thickness of 2 mm, for example, the frequency of the electromagnetic radiation λ=d=2 mm, which corresponds to a frequency of 56 GHz. A sinusoidal volume loss density profile, such as the one shown in FIG. 9, enables continuous energy to be applied across the thickness of the formed glass, which generates a heating effect inside the formed glass. Without intending to be limited by theory, this sinusoidal pattern creates a uniform temperature profile and is beneficial during volumetric heating, particularly of thick formed glass.

Referring again to FIGS. 1-5, the drawing step 150 includes drawing the formed glass 30b into the glass ribbon 30c, for example, while the formed glass 30b is volumetrically heated using heating device 50, after the formed glass 30b is volumetrically heated using device 50, or both. The formed glass 30b may be drawn into the glass ribbon 30c using edge rollers 60a, 60b. In some embodiments, the formed glass 30b is drawn into a glass ribbon 30c having a width 32 that is less than or equal to the width of sheet forming device 20 and a thickness 34 that is less than the thickness of sheet forming device 20. The method 100 further includes a cooling step 160 of cooling the glass ribbon 30c to ambient temperature. The step 160 of cooling the glass ribbon 30c can be conducted with or without external cooling. In some embodiments, edge rollers 60a, 60b can include a cooling capability for effecting some or all of the cooling within the cooling step 160.

In some embodiments, the width 32 of the glass ribbon 30c is from about 10 mm to about 5 mm, from about 20 mm to about 5 mm, from about 30 mm to about 5 mm, from about 40 mm to about 5 mm, from about 50 mm to about 5 mm, from about 100 mm to about 5 mm, from about 200 mm to about 5 mm, from about 250 mm to about 5 mm, from about 300 mm to about 5 mm, from about 350 mm to about 5 mm, from about 400 mm to about 5 mm, or any range having any two of these values as endpoints, or any open-ended range having any of these values as a lower or upper bound levels. In some embodiments, the thickness 34 is from about 0.1 mm to about 2 mm, such as about 0.2 mm to about 1.5 mm, about 0.3 mm to about 1 mm, about 0.3 to about 0.9 mm, about 0.3 to about 0.8 mm, about 0.3 to about 0.7 mm, or any range having any two of these values as endpoints, or any open-ended range having any of these values as a lower or upper bound.

Referring again to FIG. 3, the glass ribbon 30c can be sectioned into wafers 40 after cooling the glass ribbon 30c. The wafers 40 comprise maximum dimension (e.g., a diameter, width or other maximum dimension) ranging from equivalent to the width 32 of the glass ribbon 30c to 50% of the width 32 of the glass ribbon 30c. For example, the wafers 40 can have a thickness of about 2 mm or less and a maximum dimension of about 100 mm to about 500 mm. In some embodiments, the wafers 40 have a thickness of about 1 mm or less and a maximum dimension of about 150 mm to about 300 mm. The wafers 40 can also have a thickness that ranges from about 1 mm to about 50 mm, or about 1 mm to about 25 mm. The wafers 40 can also have a maximum dimension that ranges from about 25 mm to about 300 mm, from about 50 mm to about 250 mm, from about 50 mm to about 200 mm, or about 100 mm to about 200 mm. The wafers 40 formed according to the method 100, without any additional surface polishing, can exhibit the same thickness variation levels, surface roughness and/or warp levels outlined earlier in connection with the glass ribbon 30c. In some embodiments, the wafers 40 can be subjected to grinding and polishing to obtain the final dimensions of the end product, e.g., display glass for augmented reality applications. The wafers 40 are depicted in FIG. 3 as discs, however, it should be understood that the wafers 40 may comprise any of a variety of shapes including, but not limited to, squares, rectangles, circles, ellipsoids, and others.

In view of the foregoing description, it should be understood that the continuous cast and draw method described herein may be used to form glass ribbon from low viscosity glass compositions, such as those useful as augmented reality displays. The continuous cast and draw method described herein includes flowing a molten glass into a sheet forming device to form a formed glass, cooling the formed glass in the sheet forming device, conveying the formed glass from the sheet forming device, and heating and drawing the formed glass into a thin glass ribbon. In particular, the methods herein use a heating device to volumetrically heat the formed glass at a fast rate after the formed glass exits the sheet forming device and prior to drawing it into a thin glass ribbon to minimize defect formation in the glass. The continuous cast and draw method described herein enables mass production of the optical components made from low viscosity glass, such as display glass for augmented reality applications having increased uniformity and minimal defects at a reduced cost when compared to previous glass forming methods.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the specific value or end-point referred to is included. Whether or not a numerical value or end-point of a range in the specification recites “about,” two embodiments are described: one modified by “about,” and one not modified by “about.” It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A method of forming a glass ribbon, the method comprising:
flowing molten glass into a sheet forming device to form formed glass, the formed glass having a first portion and a second portion, the first portion having a larger thickness than the second portion;
volumetrically heating the formed glass using an electromagnetic heating device so that the first portion has a lower average viscosity than the second portion; and
drawing the formed glass into a glass ribbon such that the first portion is drawn with a higher rate of elongation than the second portion.

2. The method of claim 1, further comprising volumetrically heating the formed glass using the electromagnetic heating device so that a ratio of an average viscosity of the first portion to an average viscosity of the second portion is in a range from about 0.1 to about 0.8.

3. The method of claim 1, further comprising volumetrically heating the formed glass using the electromagnetic heating device so that the average viscosity of the first portion is in a range of 50 k Poise to 10⁷ Poise.

4. The method of claim 1, wherein:
the thickness of the first portion is larger than the thickness of the second portion by a predefined value, and
the rate of elongation of the first portion is higher than the rate of elongation of the second portion by the predefined value.

5. The method of claim 1, wherein:
the formed glass comprises a first outer surface, a second outer surface, and a central region disposed equidistant from the first outer surface to the second outer surface, and
during the volumetrically heating of the formed glass, a temperature of the central region in the first portion of the formed glass is greater than a temperature of the first outer surface in the first portion of the formed glass and greater than a temperature of the second outer surface in the first portion of the formed glass.

6. The method of claim 5, further comprising, during the volumetrically heating of the formed glass, heating the central region in the first portion of the formed glass to a temperature in a range of about 720° C. to about 820° C.

7. The method of claim 1, further comprising, during the volumetrically heating of the formed glass, heating the formed glass so that an average temperature of the first portion increases at a heating rate of about 15° C./second or greater.

8. The method of claim 7, further comprising, during the volumetrically heating of the formed glass, heating the formed glass so that an average temperature of the second portion increases at a heating rate less than the heating rate of the first portion.

9. The method of claim 1, wherein the molten glass comprises a borosilicate glass, an aluminoborosilicate glass, an aluminosilicate glass, a fluorosilicate glass, a phosphosilicate glass, a fluorophosphate glass, a sulfophosphate glass, a germanate glass, a vanadate glass, a borate glass, a phosphate glass, or a titanium doped silica glass.

10. The method of claim 1, wherein the electromagnetic heating device is a gyrotron microwave heating device.

11. The method of claim 10, wherein, during the volumetrically heating of the formed glass, the gyrotron microwave heating device generates electromagnetic radiation having a frequency of about 28 GHz to about 300 GHz.

12. The method of claim 1, wherein the electromagnetic heating device is an infrared heating device.

13. The method of claim 1, wherein a thickness of the first portion of the formed glass is substantially equal to a frequency of electromagnetic radiation generated from the electromagnetic heating device.

14. The method of claim 1, wherein the formed glass is drawn into the glass ribbon with a thickness variation of about 10 μm or less.

15. A glass forming system comprising:
a sheet forming device configured to receive molten glass from a melting apparatus and to form formed glass, the formed glass having a first portion and a second portion, the first portion having a larger thickness than the second portion;
an electromagnetic heating device disposed downstream of the sheet forming device along a draw pathway, the electromagnetic heating device being configured to volumetrically heat the formed glass so that the first portion of the formed glass has a lower average viscosity than the second portion of the formed glass; and
a plurality of edge rollers configured to draw the formed glass into a glass ribbon such that a thickness of the first portion of the formed glass is substantially equal to a thickness of the second portion of the formed glass in the glass ribbon.

16. The system of claim 15, further comprising one or more secondary heating devices configured to simultaneously heat the formed glass with the electromagnetic heating device.

17. The system of claim 16, wherein the one or more secondary heating devices comprises at least one of a conduction heater, a convection heater, an infrared heater, a resistance heater, an induction heater, and a flame heater.

18. The system of claim 15, wherein the electromagnetic heating device is configured to generate electromagnetic radiation having a frequency of about 5 GHz to about 500 GHz.

19. The system of claim 15, wherein the electromagnetic heating device is a gyrotron microwave heating device.

20. The system of claim 15, wherein the electromagnetic heating device is an infrared heating device.
